(19) United States
(12) Patent Application Publication
(10) Pub. No.: US 2004/0007685 A1
(43) Pub. Date: Jan. 15, 2004

(54) Rapidly actuating gate valve having function of a ball valve

(76) Inventor: Tu-Chiang Chang, Taipei (TW)

Correspondence Address: TU-CHIANG CHANG, 235 Chung-Ho, Box 8-24, Taipei, TW

(21) Appl. No.: 10/194,464

(22) Filed: Jul. 15, 2002

(51) Int. Cl. F16K 3/00

(52) U.S. Cl. 251/250; 251/326

(57) ABSTRACT

A rapidly actuating gate valve having function of a ball valve is disclosed. A rack extends from a gate. An axial control rod passes through the screw hole of the gate body and then passes through an axial hole. Then the gear of the axial control rod is exactly engaged to the rack of the gate. Retaining threads of a retaining bush around the axial control rod passes through a water-stop ring so as to be locked to the axial control rod to a screw hole of the gate body. Thereby, the axial control rod can drive the gear to rotate; and meanwhile, the rack is driven so that the gate moves upwards or downwards. Thus, the opening of the gate is controlled rapidly to control the volume of the flow. Other than the effect of the original gate, it has a function of a ball valve.

### FIELD OF THE INVENTION

The present invention relates to gate valves, and particularly to a rapidly actuating gate valve having functions of a ball valve, wherein the opening of the gate is controlled rapidly so as to control the volume of the flow. Other than the effect of the original gate, it has a function of a ball valve.

### BACKGROUND OF THE INVENTION

Referring to FIG. 1, a general used gate valve is illustrated. The gate body II of the valve I has an opening with a flow channel 111 extends from the opening. The center of the flow channel has a gate receiving chamber 112 for embedding a gate 12 capable of isolating the flow channel 111. The gate 12 is axially penetrated with a screw hole 121. A cover 13 locks and covers the gate body 11. Then rotary control rod 14 passes through the cover 13 to be locked to the screw hole 121 of the gate 12. A confining section 141 of the rotary control rod 14 is exactly in the cover 13. Then a water-stop washer is arranged between the confining section 141 of the rotary control rod 14 and the sleeve 131 of the cover 13. A nut 15 is locked to the cover 13 for confining the rotary control rod 14. The rotary control rod 14 is driven by a rotary handle 16 so that the gate 12 moves upwards or downwards. The rotary control rod 14 always retains at the original position. Thereby, if it is desired to control the movement of the gate, it must be rotated through many circles for achieving the object of opening and closing the gate. Thereby, the gate can not be opened or closed rapidly and moreover, the flow can not be controlled rapidly and precisely. Moreover, the gate can not return the original position rapidly.

### SUMMARY OF THE INVENTION

Accordingly, the primary object of the present invention is to provide a rapidly actuating gate valve having function as a ball valve. A rack extends from a gate. An axial control rod passes through the screw hole of the gate body and then passes through an axial hole. Then the gear of the axial control rod is exactly engaged to the rack of the gate. Retaining threads of a retaining-bush around the axial control rod passes through a water-stop ring so as to be locked to the axial control rod to a screw hole of the gate body. Thereby, the axial control rod can drive the gear to rotate; and meanwhile, the rack is driven so that the gate moves upwards or downwards. Thus, the opening of the gate is controlled rapidly so as to control the volume of the flow. Other than the effect of the original gate, it has functions of a ball valve.

Another object of the present invention is to provide a rapidly actuating gate valve having functions as a ball valve, wherein the retaining nut is formed with a receiving hole for receiving a spring and a steel ball. A periphery of the rectangular hole is circularly installed with a plurality of positioning grooves at positions with respect to the receiving hole. When the rectangular hole of the handle is engaged to the cutting surface of the axial control rod, by the buckling of one positioning groove and the steel ball being resisted by the spring-, the gate is prevented from moving downwards by itself.

The various objects and advantages of the present invention will be more readily understood from the following detailed description when read in conjunction with the appended drawing.

### BRIEF DESCRIPTION OF THE DRAWINGS

FIG. 1 is an assembled cross sectional view of a prior art gated valve.

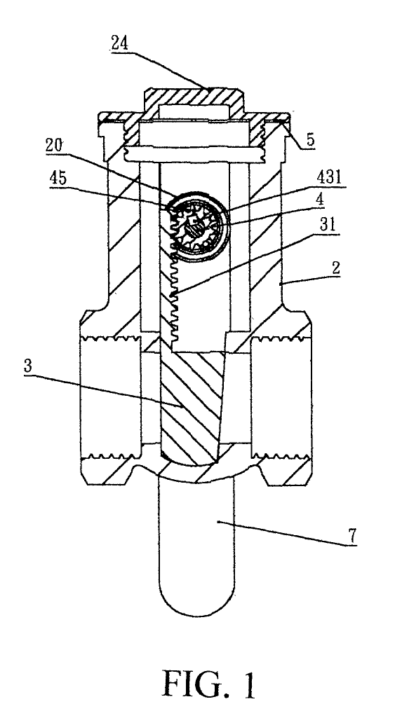

FIG. 2 is an exploded perspective view of the parts of the present invention.

FIG. 3 is an assembled perspective view of the present invention.

FIG. 4 is an assembled cross sectional view of the present invention.

FIG. 5 is a cross sectional view about the opening of the gate according to the present invention.

FIG. 6 is a schematic view showing operation of the controlling of the gate according to the present invention.

FIG. 7 is a schematic view showing the handle of the present invention before it is positioned.

FIG. 8 is a schematic view showing the handle of the present invention after it is positioned.

### DETAILED DESCRIPTION OF THE PREFERRED EMBODIMENTS

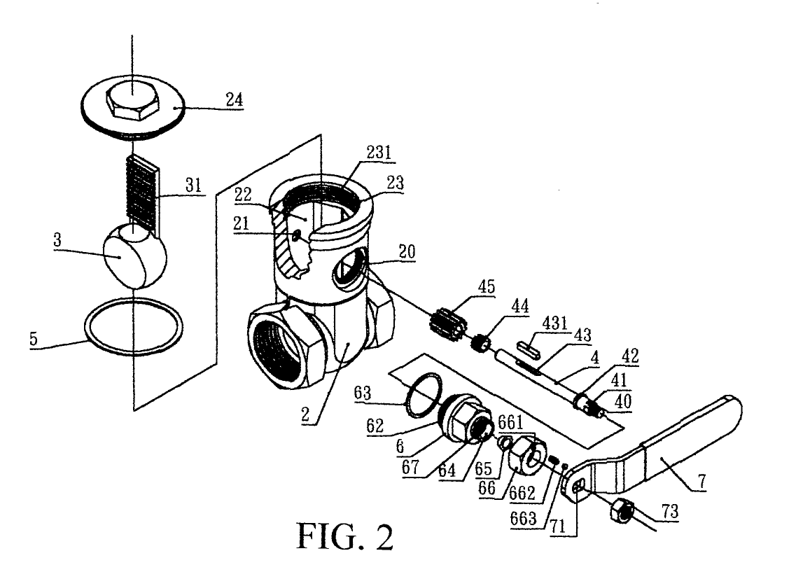

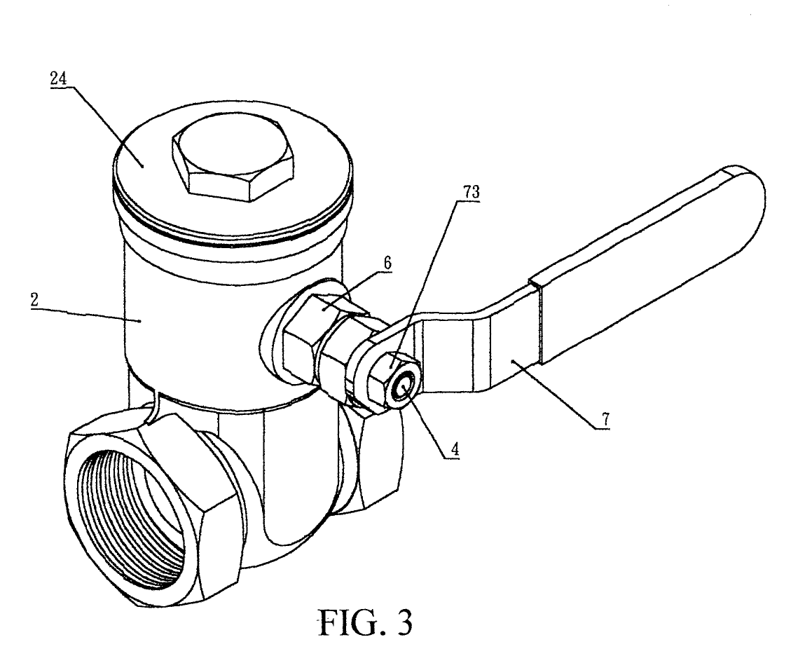

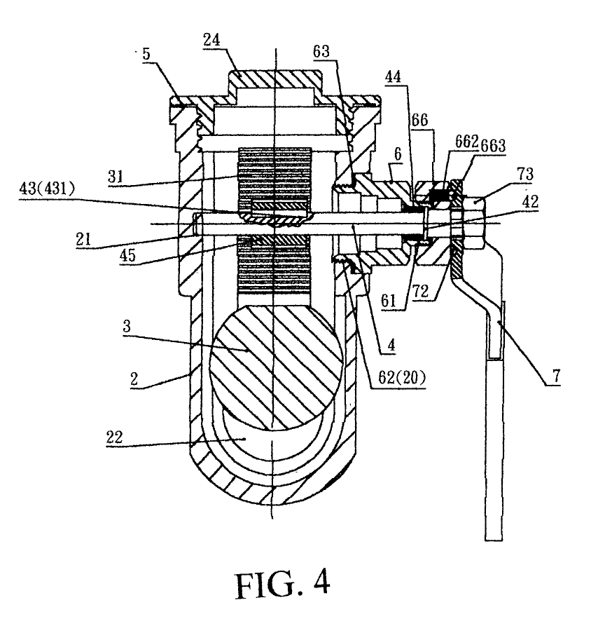

Referring to FIGS. 2, 3 and 4, a gate body 2 is axially formed with a screw hole 20 and an axial hole 21 is formed at an opposite side of the gate body 2. The internal of the gate body 2 has a receiving groove 22 for placing a gate 3. The gate body 2 has an opening 23. The inner side of the opening 23 has threads 231 for locking a cap 24. Meanwhile, a drain-preventing pad 5 is tightly engaged between the cap 24 and the opening 23. The gate 3 is connected to a rack 31 extending upwards. An axial control rod 4 has a front end. The front end is installed with a screw rod 40 and the screw rod 40 is adjacent to a cutting surface 41. A rear side of the cutting surface 41 has a confining ring 42. A pin hole 43 is installed at a middle section of the axial control rod 4. The axial control rod 4 passes through a retaining bush 6 so that the confining ring 42 of the axial control rod 4 is in the stepped screw hole 61 of the retaining bush 6. Then a confining sleeve 44 encloses the axial control rod 4 so as to lock to the stepped screw hole 61 of the retaining bush 6. Thereby, the confining ring 42 of the axial control rod 4 is positioned between the confining sleeve 44 and the stepped screw hole 61 and thus the axial control rod 4 can rotate idly and not move out of position. A pin 431 is formed in the pin hole 43 of the axial control rod 4. A gear 45 is positioned on the pin 431. The axial control rod 4 passes through the screw hole 20 of the gate body 2 and then is positioned across the axial hole 21. The gear 45 is exactly engaged with the rack 31 of the gate 3. Meanwhile, a water-stop ring 62 encloses the retaining thread 62 of the retaining bush 6 so as to lock the axial control rod 4 to the screw hole 20. Thus, the axial control rod 4 may drive the gear 45 to rotate. At the same time, the rack 31 can be actuated to drive the gate 3 to move upwards or downwards to control the opening of the gate 3. Thus the flow rate is controllable.

The part of the axial control rod 4 protrudes out of the tapered hole 64 of the retaining bush 6 is combined with a sector drain-preventing washer 65. A positioning nut 66 locks the positioning thread 67 of the retaining bush 6 so as to tighten the sector drain-preventing washer 65 to a tapered hole 64 to prevent the water from draining out. To avoid that the gate 3 moves downwards by itself as the gate 3 is opened, an end surface of the retaining nut 66 is formed with a receiving hole 661 for receiving a spring 662 and a steel ball 663. A periphery of the rectangular hole 71 of the handle 7 is circularly installed with a plurality of positioning grooves 72 at positions with respect to he receiving hole 661. Thereby, when the rectangular hole 71 of the handle 7 is engaged to the cutting surface 41 of the axial control rod 4, by the buckling of one positioning groove 72 and the steel ball 663 being resisted by the spring 662, the gate 3 is prevented from moving downwards by itself. Then a retaining female screw 73 is locked to the screw rod 40 of the axial control rod 4, the handle 7 may drive the axial control rod 4.

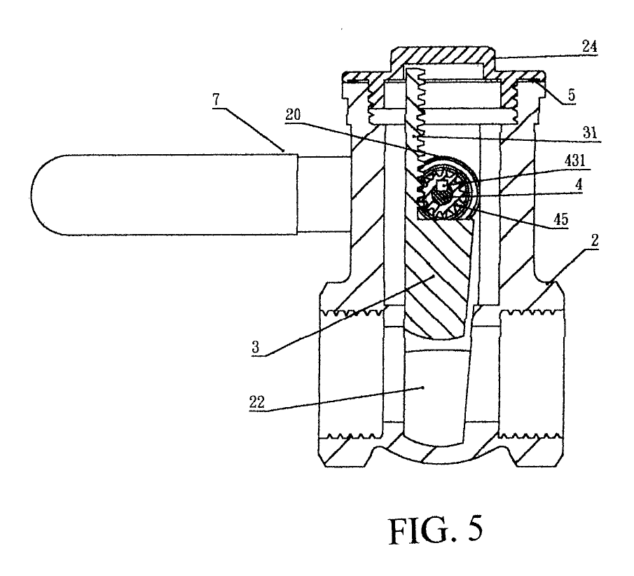

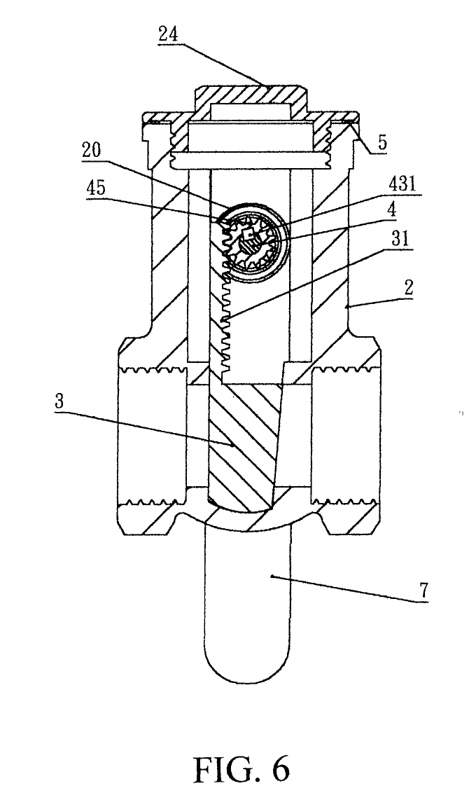

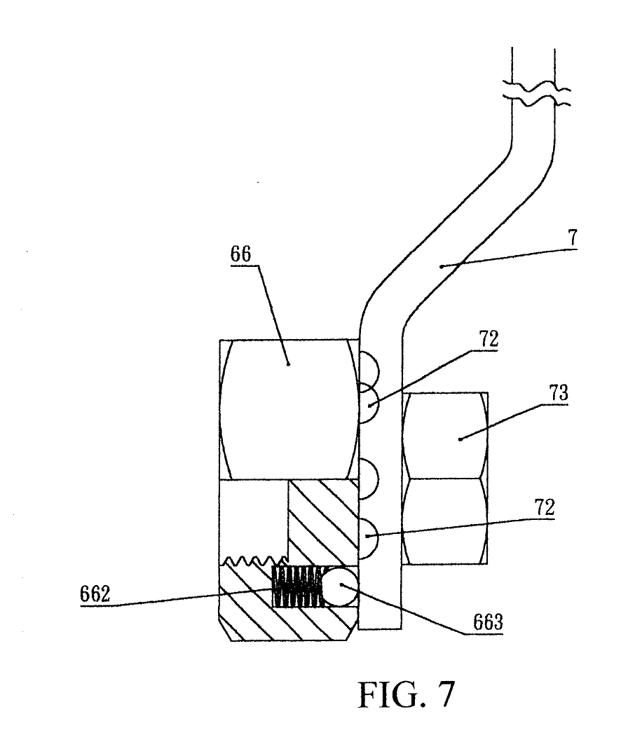

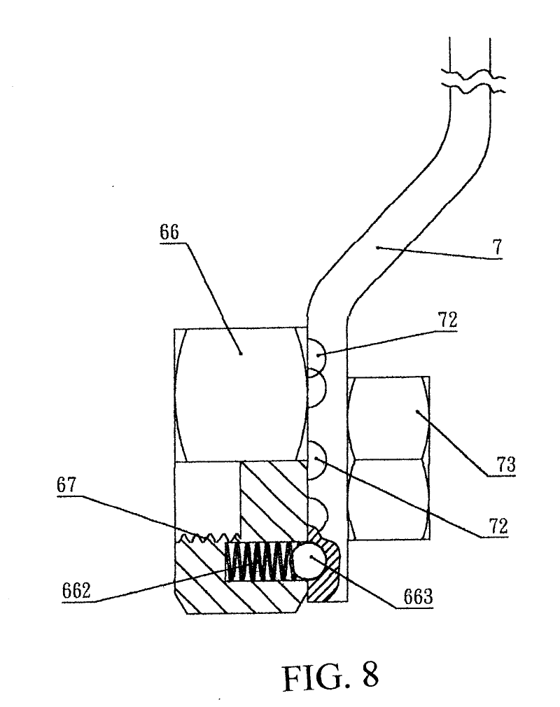

With reference to FIG. 5, when the handle 7 drives the axial control rod 4, the gate 3 is engaged to the rack 31. Thus when the gear 45 rotates, the rack 31 is driven to move downwards, so that the gate 3 will close rapidly, as shown in FIG. 6. When the handle 7 moves along an opposite direction, the axial control rod 4 rotates, the gear 45 will drive the rack 31 to move upwards and thus the gate 3 moves upwards so as to open the flow channel. Therefore, the opening of the gate 3 is controlled by the movement of the handle 7. Referring to FIG. 7, when the handle 7 is moved, the positioning groove 72 will resist against the steel ball 663 to compress the spring 662 so that the handle 7 rotates easily. Moreover, the spring 662 is tightly coupled to the handle 7 so that the gate 3 does not move downwards by itself. With reference to FIG. 8, the steel ball 663 can be received in the positioning groove 72 of the handle 7, so that the gate 3 is positioned by the handle 7 and does not move downwards.

Therefore, in the present invention, the gear on the axial control rod is engaged to the rack on the gate. The gear will drive the rack to move upwards or downwards so that the opening of the gate is controlled by the movement of the handle. Then, by the positioning effect of the handle, other than the original effect of the valve, the valve can be controlled easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A rapidly actuating gate valve having functions as a ball valve;
comprising:
a gate body is axially formed with a screw hole at one side and an axial hole being formed at an opposite side of screw hole in the gate body
a gate extending with a rack;
an axial control rod fixed with a gear; a front end of the axial control rod having a confining ring;
a retaining bush locked to the screw hole of the gate body; the axial control rod passing through the retaining bush and being stopped in a stepped hole of the retaining bush; a confining sleeve enclosing the axial control rod and being lock to a stepped screw hole of the retaining bush; so that a screw rod of the axial control rod and a cutting surface protrudes out of a tapered hole of the retaining bush; thus, when the axial control rod rotates idly, it will not displace;
a positioning nut passing through the axial control rod to be locked to positioning thread of the retaining bush; a sector drain-preventing washer being tightly placing in the tapered hole for fixing; and
a handle having a rectangular hole; the handle being installed to the cutting surface of the axial control rod by the rectangular hole; and the handle being locked to a screw rod by a female screw;
wherein the axial control rod passes through the screw hole of the gate body and then passes through the axial hole, then the gear of the axial control rod is exactly engaged to the rack of the gate; retaining threads of the retaining bush passing through a water-stop ring so as to be locked to screw hole; thereby, the axial control rod can drive the gear to rotate; and meanwhile, the rack is driven so that the gate moves upwards or downwards; thus, the opening of the gate is controlled rapidly so as to control the volume of the flow; other than the effect of the original gate, it has a function of a ball valve.

2. The rapidly actuating gate valve having functions as a ball valve as claimed in claim 1, wherein an end surface of the retaining nut is formed with a receiving hole for receiving a spring and a steel ball; a periphery of the rectangular hole of the handle of the receiving hole is circularly arranged with a plurality of positioning grooves at positions with respect to the receiving hole; thereby, when the rectangular hole of the handle is engaged to the cutting surface of the axial control rod, by the buckling of one positioning groove and the steel ball being resisted by the spring, the gate is prevented from moving downwards by itself.
